(19) United States
(12) Patent Application Publication
(10) Pub. No.: US 2022/0099605 A1
(43) Pub. Date: Mar. 31, 2022

(54) A MEASUREMENT MECHANISM

(71) Applicant: TUSAS- TURK HAVACILIK VE UZAY SANAYII ANONIM SIRKETI, Ankara (TR)

(72) Inventors: Deger AKIN, Kazan/Ankara (TR); Dilek KUMLUTAS, Bornova/Izmir (TR); Furkan KULAK, Kazan/Ankara (TR)

(73) Assignee: TUSAS- TURK HAVACILIK VE UZAY SANAYII ANONIM SIRKETI, Ankara (TR)

(21) Appl. No.: 17/418,125

(22) PCT Filed: Dec. 20, 2019
(86) PCT No.: PCT/TR2019/051133

§ 371 Date: Jun. 24, 2021

(30) Foreign Application Priority Data
Dec. 28, 2018 (TR) 2018/21033

(51) Int. Cl. G01N 25/18

(52) U.S. Cl. CPC G01N 25/18

(57) ABSTRACT

A measurement mechanism that has a body, a vacuum chamber located on the body and in which a measurement process is performed is disclosed. A first sample and a second sample between which a heat transfer occurs are placed in the vacuum chamber and contact each other. A piston that provides the first sample and the second sample to continuously contact each other, a measurement unit that contacts the first sample and the second sample, a heater located above the first sample, and a cooler located below the second sample is also disclosed.

The present invention relates to a measurement mechanism which provides measuring thermal contact resistance.

Especially in space and air vehicles, honeycomb sandwich panels having carbon fibre-reinforced plate surfaces are commonly used. While various equipment and components provided in space vehicles may be fixed directly to such panels, the fixing process is performed by means of supports. Equipment, components and/or supports which are fixed to these panels may be made of metallic materials. For that reason, precise determination of thermal contact resistance, which is generated as a result of fixing the equipment, components and/or supports to the panels, is a significant factor for thermal control design of the space vehicle. While measuring the thermal contact resistance, it is provided that at least two samples contact each other. A heat transfer occurs between two samples.

Meanwhile, the thermal contact resistance is measured by performing a measurement. Said test is executed in an environment without air interaction. A pressure allows two samples to be in a continuous contact with each other. The continuous pressure is provided by means of a high power piston. However, the force applied to the piston is difficult to be transmitted to the samples. For that reason, an element is required which provides power transfer on the piston.

Chinese patent application no. CN102645449 covered by the known art discloses a test mechanism in which the power transmission is provided by means of a screw.

In another published document titled as “Predicting Thermal Contact Resistance at Cryogenic Temperatures for Spacecraft Applications” (Maddren J. et al, Journal of Spacecraft and Rockets, vol. 32, no. 3, 1 May 1995, pages 469-474), thermal contact resistance measurement comparison at cryogenic temperatures and at room temperatures for spacecraft applications is disclosed. In order to comparison, an experimental apparatus is also disclosed. This apparatus comprises a vacuum environment in which two specimens contacting each other are provided, a heater provided at the upper side of the specimens and a cooling system provided at the lower side of the specimens. Thanks to heater and cooling system, a heat flow over the specimens from heater to cooling system is ensured to measure thermal contact resistance. In order to measurement, a heat meter is provided between the cooling system and the lower specimen. For ensuring the contact of the specimens, a load cell is provided at the outside of the vacuum chamber and a lever arm in connection with the load cell and located inside the vacuum chamber is provided. The load is applied by the lever arm through a flexible bellows at the top of the chamber. In this document, the deformation characteristics affecting the thermal contact resistance of materials contacting to each other is focused and the difficulty of force transmission to the samples is not dealt.

Yet in other published document titled as “Thermal contact resistance across pressed metal contacts in a vacuum environment” (T. Mcwaid et al, International Journal of Heat and Mass Transfer, vol. 35, 1 Nov. 1992, pages 2911-2920), thermal contact resistance measurement change according to contact surfaces of the specimens is disclosed. Accordingly, it is stated that in order to predict the thermal contact resistance across a given pressed contact, one must be able to predict the number and average size of the many microcontacts that comprise the actual contact area. Through this phenomenon, use of an experimental apparatus described above is disclosed. By this apparatus contact points between different specimens especially having rough surfaces are observed. Accordingly, an elastic contact model for the determination of the parameters required for the prediction of the contact resistance can be obtained. However also in this document, the difficulty of force transmission to the samples is not dealt.

An object of the present invention is to provide a measurement mechanism which provides ease of use.

The measurement mechanism aimed to achieve the object of the present invention and disclosed in the claims comprises a body, and a vacuum chamber which is located on the body. The vacuum chamber comprises therein a first sample and a second sample between which a heat transfer occurs; a piston which exerts a continuous pushing force in order for the first sample and the second sample to contact each other; a measurement unit which is located between the first sample and the second sample and provides measuring the heat transfer between the first sample and the second sample; and a cooler which is located below the first sample and the second sample.

The measurement mechanism, which is the subject matter of the present invention, comprises a bellows which is located to at least partially cover the piston. Thanks to the bellows, the force applied to the piston is decreased. Therefore, more accurate results are obtained with less force. Since the force applied to the piston is also transferred onto the bellows, it is transmitted to the first sample and the second sample without decreasing. Therefore, the efficiency is increased. The bellows has a first position and a second position. When the bellows is in the first position, the piston applies a force onto the first sample and the second sample. The length of the bellows decreases. When the bellows is in the second position, pressure between the first sample and the second sample is decreased and length of the bellows increases.

In an embodiment of the invention, the measurement mechanism comprises a positioning element through which the piston enters into the vacuum chamber and which provides guiding the piston, and a plate which provides transmitting the force of the piston to the samples. The bellows is located between the positioning element and the plate.

In an embodiment of the invention, the measurement mechanism comprises a bellows which is made of a metal material. Therefore, maintenance and cleaning of the bellows is facilitated.

In an embodiment of the invention, the measurement mechanism comprises a fixing element which is located on a surface of the bellows contacting the positioning element. The fixing element is located peripherally on the bellows. The positioning element is fixed on the vacuum chamber. The positioning element and the fixing element contact each other in parallel.

In an embodiment of the invention, the measurement mechanism comprises a foldable bellows. Thus, it is provided that force of the piston is transmitted in a balanced manner. The metal bellows comprises an elastic material at the folding points. Therefore, mobility is improved.

With the present invention, there is disclosed a measurement mechanism which comprises a bellows located on the piston that provides improving the efficiency and ease of use.

The measurement mechanism aimed to achieve the object of the present invention is illustrated in the attached figures, in which:

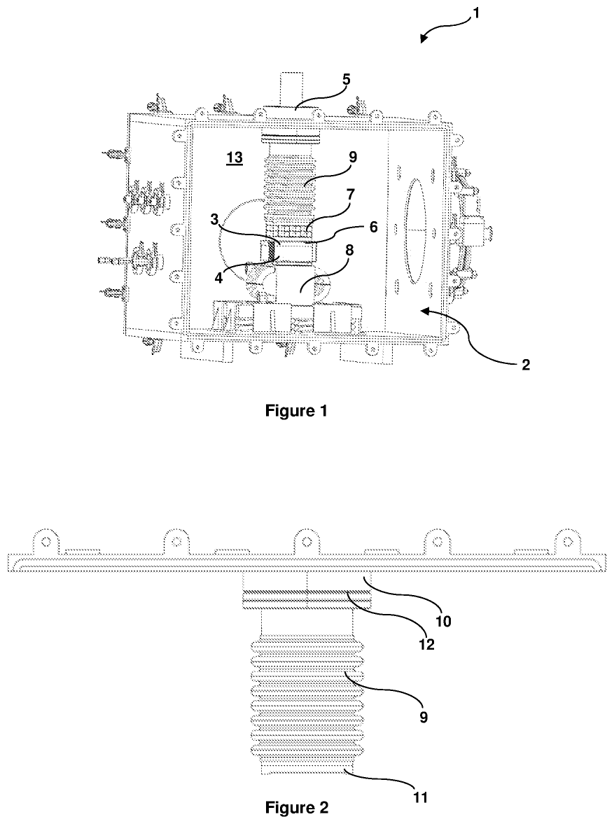

FIG. 1 is a perspective view of a measurement mechanism.

FIG. 2 is a side view of a bellows, a positioning element, a plate and a fixing element.

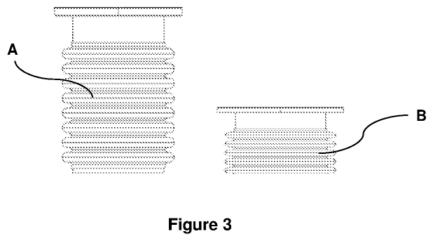

FIG. 3 is a view of the bellows in the first position (A) and the second position (B).

All the parts illustrated in figures are individually assigned a reference numeral and the corresponding terms of these numbers are listed below.
1—Measurement mechanism
2—Vacuum chamber
3—First sample
4—Second sample
5—Piston
6—Measurement unit
7—Heater
8—Cooler
9—Bellows
10—Positioning element
11—Plate
12—Fixing element
13—Body
B—First position
A—Second position

The measurement mechanism (1) comprises a body (13); a vacuum chamber (2) which is located on the body (13) and in which a measurement process is performed; a first sample (3) and a second sample (4) between which a heat transfer occurs, which are placed in the vacuum chamber (2) and contact each other; a piston (5) which provides the first sample (3) and the second sample (4) to continuously contact each other; a measurement unit (6) which contacts the first sample (3) and the second sample (4); a heater (7) located above the first sample (3); and a cooler (8) located below the second sample (4). A thermal flow is generated on the measurement mechanism (1) from the heater towards the cooler (8). Thanks to the piston (5), the first sample (3) and the second sample (4) continuously contact each other. Therefore, it is provided that the measurement unit (6) is able to measure thermal contact resistances of the first sample (3) and the second sample (4) in the presence of thermal flow. By performing the measurement process in the vacuum chamber, external environment factors do not affect the measurement results. Thus, more accurate measurement results are provided.

The measurement mechanism (1), which is the subject matter of the present invention, comprises a bellows (9) located to at least partially cover the piston (5) and having a first position (B) in which the bellows (9) provides the first sample (3) and the second sample (4) to apply pressure to each other and a second position (A) in which the bellows (9) provides decreasing the pressure on the first sample (3) and the second sample (4). When the bellows (9) is in the first position (B), the first sample (3) and the second sample (4) contact each other with the effect of pressure. Thus, a heat transfer occurs between the first sample (3) and the second sample (4), and the measurement is performed. The bellows (9) is in the second position (A) when there is no measurement to be performed. The bellows (9) covers the piston (5) at full-length.

In an embodiment of the invention, the measurement mechanism (1) comprises a positioning element (10) which is located at a part where the piston (5) enters into the vacuum chamber (2); a plate (11) which is located below the piston (5) and provides transmitting the force of the piston (5); and a bellows (9) which is located between the positioning element (10) and the plate (11). The positioning element (10) provides that the piston (5) is centred upon entering into the vacuum chamber (2) and transmits the power linearly. The plate (11) contacts the first sample (3) to provide transmitting pressure of the piston (5). The bellows (9) is located between the positioning element (10) and the plate (11) to provide covering the piston (5).

In an embodiment of the invention, the measurement mechanism (1) comprises a bellows (9) which is made of a metal material. Due to the fact that the bellows (9) is made of a metal material, mechanical strength thereof is improved.

In an embodiment of the invention, the measurement mechanism (1) comprises a positioning element (10) which is fixed on the vacuum chamber (2) and a fixing element (12) which is located on a surface of the bellows (9) contacting the positioning element (10). Thanks to a fixing element (12) located on the bellows (9); it is provided that the bellows (9) is centred on the piston (5). The fixing element (12) is in superficial contact with the positioning element (10). Therefore, a friction force is formed between the fixing element (12) and the positioning element (10) and the bellows (9) is provided to be fixed.

In an embodiment of the invention, the measurement mechanism (1) comprises a foldable bellows (9) which provides balancing the force of the piston (5). Due to the foldable structure of the bellows (9), power transmitted by the piston (9) is spread onto the bellows (9). Thus, power transmission is facilitated.

With the present invention, there is achieved a measurement mechanism (1) which provides power transmission by means of a piston (5) on which a bellows (9) is arranged. Thanks to the metal bellows (9) located on the piston (5), the piston (5) is facilitated to transmit power onto the samples.

1. A measurement mechanism (1) which comprises a body (13); a vacuum chamber (2) which is located on the body (13) and in which a measurement process is performed; a first sample (3) and a second sample (4) between which a heat transfer occurs, which are placed in the vacuum chamber (2) and contact each other; a piston (5) which provides the first sample (3) and the second sample (4) to continuously contact each other; a measurement unit (6) which contacts the first sample (3) and the second sample (4); a heater (7) located above the first sample (3); and a cooler (8) located below the second sample (4), characterized by a bellows (9) made of a metal material, being located to cover the piston (5) at full-length and having a first position (B) in which the length of the bellows is decreased and in which the bellows (9) provides the first sample (3) and the second sample (4) to apply pressure to each other and a second position (A) in which the length of the bellows (9) is increased and in which the bellows (9) provides decreasing the pressure on the first sample (3) and the second sample (4); a positioning element (10) which is located at a part where the piston (5) enters into the vacuum chamber (2); a plate (11) which is located below the piston (5) and provides transmitting the force of the piston (5) wherein the bellows (9) is located between the positioning element (10) and the plate (11).

2-3. (canceled)

4. The measurement mechanism (1) according to claim 1, characterized in that the positioning element (10) is fixed on the vacuum chamber (2), and in that the measurement mechanism (1) comprises a fixing element (12) which is located on a surface of the bellows (9) contacting the positioning element (10).

5. The measurement mechanism (1) according to claim 1, characterized in that the bellows (9) is foldable such that it is configured to provide balancing the force of the piston (5).
